(19) United States
(12) Patent Application Publication
(10) Pub. No.: US 2008/0310288 A1
(43) Pub. Date: Dec. 18, 2008

(54) Universal Numerical Disc of Optically Readable Type

(75) Inventor: Hilal Fetouhi, Nanteuil les Meaux (FR)

Correspondence Address: POWELL GOLDSTEIN LLP, ONE ATLANTIC CENTER FOURTEENTH FLOOR, 1201 WEST PEACHTREE STREET NW, ATLANTA, GA, 30309-3488, US

(73) Assignee: DIGITAL VALLEY INDUSTRIES S.A.S., Val De Reuil (FR)

(21) Appl. No.: 11/994,082

(22) PCT Filed: Apr. 28, 2006
(86) PCT No.: PCT/EP06/61927

§ 371 Date: Jun. 11, 2008

(30) Foreign Application Priority Data
Jun. 28, 2005 (FR) 0551797

(51) Int. Cl. G11B 3/70

(52) U.S. Cl. 369/272.1

(57) ABSTRACT

A universal numerical disc comprising an essentially single moulded generally planar part having a printing side and a readable side carrying encoded data. The moulded part has a central opening and a ring-shaped area with increased thickness, disposed concentrically around the central opening at the side of the reading side, which reading side is provided with a protective resin coating.

### PRIORITY CLAIM

This patent application is a U.S. National Phase of International Patent Application No. PCT/EP2006/061927, filed Apr. 28, 2006, which claims priority to French Patent Application No. 0551797, filed Jun. 28, 2005, the disclosures of which are incorporated herein by reference in their entirety.

### FIELD

The present disclosure relates to a universal numerical disc of the optically readable type.

### BACKGROUND

Optical discs of the optically readable type are known per se, for instance, from U.S. Pat. No.6,051,298 which describes a high density optical disc that is protected against scratches and fingerprints by providing the disc with two protective films. Optical disks in general comprise compact discs (hereinafter, referred to as a CD) and digital video discs (hereinafter referred to as a DVD). An optical disc in the format of a CD usually comprises a disc substrate provided with encoded data information tracks in the form of pits and bosses on its readable side. A reflection film formed in the pits of the disc substrate to reflect the incident laser beam and a protective film formed on the reflection film complete the CD. The reflection and protective films are usually about 0.05 micron and 10 micron thick, respectively. To be able to read the CD reliably with the current optical readers, the known CD must have a thickness of about 1.2 mm. The known optical disc in DVD format is a composite of two substrate discs which are bonded onto each other. In the case of the format referred to as DVD-5, single side single layer, one of the substrates (generally referred to as layer 0) carries the coded data in the form of pits and bosses on one of its sides, namely the readable side, whereas the other substrate is essentially transparent. After metallizing the readable side of the data substrate, the data substrate and the second substrate are bonded with the transparent second substrate disposed against the readable side of the data substrate. A DVD for a double-sided recording system is composed of two disc substrates, each provided with information tracks on its readable side. The DVD further comprises reflection films for each readable side, protective films on the reflection films, and an adhesion layer between the protective films for adhering the two disc substrates to each other. Typically, each substrate has a diameter of about 120 mm and a thickness of about 0.59 mm. This results, when accounting for the thickness of the adhesive layer, in a thickness of the finished optical DVD disc of about 1.2 mm. If desired, the exterior side of the data substrate is usually offset printed or printed serigraphically with information for easy reference.

In order to be playable on commercially available optical reading devices, the known optical discs have to satisfy constraints with respect to dimensions and weight, both of which have been normalized by the industry.

The normalization standard prescribes a disc thickness of about 1.2 mm. Moreover the disc must comprise a clamping area of about D2=22 mm to D3=33 mm in diameter around the central hole, which has a diameter of about D1=15 mm. In order to play the optical disc in an optical playing apparatus, the disc is placed on a disc support which forms part of the record clamping device and takes the form of a flange which is disposed on the drive spindle of the optical reader. The disc is clamped between two holding means which close onto the clamping area. To be able to satisfactorily clamp the disc, the clamping area has to have sufficient thickness. If not clamped sufficiently, the disc will not rotate stably and therefore will not be readable or will be only partly readable.

A typical optical reader comprises a light source in the form of a laser which, via a number of possible optical means, emits a light beam towards a focussing device. The focussing device, including an objective or lens, is mounted on a carriage which is radially movable relative to the support plate of the disc. The light beam is projected onto the readable surface of the disc by the objective, then transverses one of the substrates and is focussed on the information tracks. The light beam, reflected by the light-reflecting layer of the disc and modulated by the information contained on the disc, returns through the transparent substrate of the disc and the air between the disc and the objective to the optical system of the optical reader, where it is separated from the onward beam in a suitable manner after which a conversion from light beam modulation into electrical modulation takes place. When played, typical rotational speeds are from 10 Hz to 180 Hz. A moulded DVD is always slightly asymmetric, which gives rise to oscillations with amplitudes typically amounting to 100 micron for each complete rotation at a speed of 23 Hz (i.e., 23 revolutions per second, which corresponds to single speed). The track on a disc, therefore, is subject to both radial and axial displacements, which necessitates an automatic control of the position of the reading head. An optical reader is preferably equipped with a light detector and a displaceable objective which allows the laser spot to move rapidly in a restricted region, typically within a few hundred tracks. When a misalignment occurs in the radial direction and/or in the direction perpendicular to the disc surface, the intensity of light captured by the light detector will change, causing a corrective movement of the objective to restore correct alignment. Displacement of the reading head of optical readers in the direction perpendicular to the disc surface is also needed to find the starting data of the disc, to determine the format of the disc and to focus. Typically, known readers are able to adjust their focal position in order to read DVD 5/HD DVD 15 layer 0 data, DVD 9/HD DVD 30 layer 1 data and CD data.

The thickness of about 1.2 mm of the known optical disc not only ensures a suitable clamping of the disc by the clamping means of the reader, but also enables the laser spot to focus by means of the lens on the reading side of the data substrate. Because of the thickness of the known disc, the disc has sufficient bending and torsional stiffness to withstand excessive deformation while rotating at elevated speeds and, therefore, only needs minor corrections with respect to focussing.

However, the known optical disc has several disadvantages. The cost of the materials primarily used in producing the disc is increasing, in particular, the cost of polycarbonate polymer used in moulding the disc. This makes the production of the known disc uneconomical. Moreover, the weight of the known disc renders it less attractive in applications such as publicity discs to be inserted in journals and magazines.

### SUMMARY

The present disclosure describes several exemplary embodiments of the present invention.

One aspect of the present disclosure provides a universal numerical disc comprising an essentially single moulded generally planar part having a printing side and a readable side carrying data encoded in a known manner, the moulded part having a central opening and a ring-shaped area with increased thickness, disposed concentrically around the central opening at the side of the reading side. The reading side has a protective resin coating.

The present invention aims to solve these and other inconveniences of the known disc. In particular, one feature of the present disclosure provides a universal numerical disc that can be produced in an economical manner and that is compatible with the use of discs of this format in the area of publicity. Moreover, another feature of the present disclosure provides a universal numerical disc of lesser weight than the known disc, albeit compatible with, i.e., readable by, commercially available optical readers.

The present disclosure provides a universal numerical disc comprising an essentially single moulded generally planar part having a printing side and a readable side carrying encoded data in a known manner, the moulded part having a central opening and a ring-shaped area with increased thickness, disposed concentrically around the central opening at the side of the reading side, which reading side is provided with a protective resin coating. According to the present disclosure, the increased thickness area preferably has a thickness which allows the disc to be satisfactorily clamped in commercially available optical readers. For purposes of the present disclosure, increased thickness means that the area has an average thickness which is larger than the thickness of the remainder of the disc, i.e., the volume of the disc which is outside the ring-shaped area. Since the known disc, including its clamping area, has a total thickness of about 1.2 mm, the disc according to the present disclosure will have an average thickness outside the ring-shaped area which is lower than that of the known disc. Consequently, the stiffness of the disc according to the present disclosure will on average be lower, and preferably substantially lower, than the stiffness of currently available discs. Due to this lower stiffness, one would expect deformation of the disc when read in an optical reader and, consequently, problems with readability and/or damage during play. Surprisingly, these problems do not occur. Although the inventors are uncertain about the exact reasons for this unexpected behavior, and, while not wishing to be bound by any particular theory, it may be that the combination of the centrally disposed stiffer ring-shaped area and centrifugal forces which act on the disc during rotation straighten the disc sufficiently in a plane transverse to the axis of the drive spindle. The fact that the ring-shaped area with increased thickness is not only disposed concentrically around the central opening but extends at the side of the reading side may also be beneficial. Since the disc according to the present disclosure is thinner on average than the known discs, the disc according to the present disclosure will use less material and, therefore, will be cheaper to produce. The central increased thickness area simultaneously allows clamping of the disc in commercially available optical readers, and controls deformation of the disc during reading, such that it is readable in such optical readers.

The disc substrate provided with tracks in the form of pits and bosses may be made in one process step using known processes such as compression and injection moulding, photo polymerization processes and so on. In principle, all substantially transparent polymers may be used to manufacture the disc, such as, for instance, polycarbonate (PC) and polymethylmethacrylate (PMMA) and copolymers thereof. After moulding of the disc, readable side of the disc is metallized, for instance, by applying a reflection film through processes such as vacuum evaporation and sputtering, and is usually made of aluminum. The disc is further provided with a protective resin coating to protect the reflection side from damage which may, for instance, arise from general physical contact and from oxidation. This protective layer is preferably applied by means of a spin-coating process wherein the protective resin material is applied through a rotatory movement.

In one exemplary embodiment, the ring-shaped area with increased thickness has an interior diameter essentially equal to the diameter of the central opening. This allows for easy clamping of the disc in known optical reading apparatus.

Although the diameter of the centrally disposed ring-shaped area with increased thickness may vary between a value just larger than the diameter of the central opening and a value just smaller than the outer diameter of the disc, the ring-shaped area with increased thickness has, in another exemplary embodiment, an exterior diameter less than about 32 mm. This diameter range proved to yield optimal clamping of the disc and excellent readability even after prolonged use of the disc.

In still another exemplary embodiment, the singly moulded part has a thickness of the order of 0.60 mm to 0.62 mm, and the ring-shaped area with increased thickness has a thickness which is of the order of 0.40 mm larger, i.e., 1.00 mm to 1.02 mm in total. A problem with known discs is absorption or desorption of moisture which preferably occurs at the interface between the two bonded substrates. Ingress of moisture may lead to local differences in water concentration in the disc and, consequently, to warpage thereof. As a result, the laser light ray reading the disc will not travel along the center of a track, resulting in a deterioration of the signal quality. Warpage may be so severe that the feedback mechanism as described above will not be able to correct for the warpage, thereby rendering the disc temporarily unreadable. Since the disc according to the present disclosure is not composed of adhesively bonded substrates, the disc is less prone to warpage.

In still another exemplary embodiment, the disc according to the present disclosure comprises, among others, a ring-shaped rib concentrically disposed around the central opening at the side of the reading side. This rib provides adequate clamping at a further decreased weight.

### BRIEF DESCRIPTION OF THE DRAWINGS

The present disclosure will now be further elucidated on the basis of the non-limitative exemplary embodiment shown in the following figures.

FIG. 1 is a cross-sectional view of the clamping area of an optical reader;

FIG. 2 is a schematic view illustrating the feedback mechanism to correct for misalignment of the laser bundle;

FIG. 3 is a graph of the focal strength FE variation with height;

FIG. 4 is a cross-sectional view of a universal numerical disc of the present disclosure;

FIG. 5 is an enlarged view of detail V of FIG. 4;

FIG. 6 is a cross-sectional view of another exemplary embodiment of the present disclosure, and

FIG. 7 is an enlarged view of the central part of FIG. 6.

### DETAILED DESCRIPTION

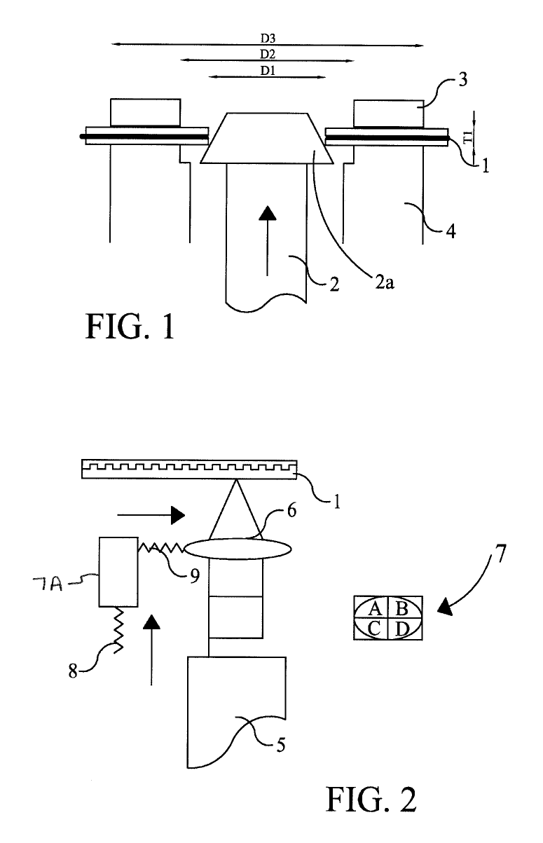

In FIG. 1, part of an optical disc 1 is shown. Disc 1 is provided with a central opening with diameter D1. The disc 1 is supported by a flange 2a which is disposed on the drive spindle 2 of the optical reader. A clamping area is provided which permits clamping of the disc 1 with the aid of two holding means 3 and 4, whereby the disc 1 is centered through flange 2a. In this way, the disc 1 may be rotated in the optical reader in a stable manner. For purposes of the present disclosure, the clamping area is that part of the disc which extends between diameters D2 and D3. To be able to satisfactorily clamp the disc 1, the clamping area has to have a sufficient thickness T1. The normalization standard prescribes a clamping area of about D2=22 mm to D3=33 mm in diameter, while the diameter of the central hole is about D1=15 mm.

As shown in FIG. 2, an optical reader typically comprises a laser 5, an astigmatic lens 6 and a light detector 7 with four photo detectors A, B, C and D. Light detector 7 senses the laser light reflected from the disc 1 and functions similarly to a film camera with only four pixels. The objective 7A is mounted on springs 8 in the axial direction and on springs 9 in the radial direction, and may be displaced by electromagnets (not shown). The laser spot may in this way be displaced rapidly in a restricted region, typically within a few hundred tracks of disc 1. The lens 6 and the laser 5 are usually mounted on a movable support or sledge (not shown), which may be displaced in the radial direction over the total data area of the disc 1. Since the lens 6 is diagonally astigmatic, a misalignment, for instance, due to an unwanted deformation of the disc 1, causes a brighter light in either detectors A and D (in case the lens is positioned too high), or in detectors B and C (in case the lens is positioned too low). This information suffices to sense the radial and axial position of the lens 6. The focal strength FE is calculated as FE=A+D−(B+C) which gives a surprisingly good result.

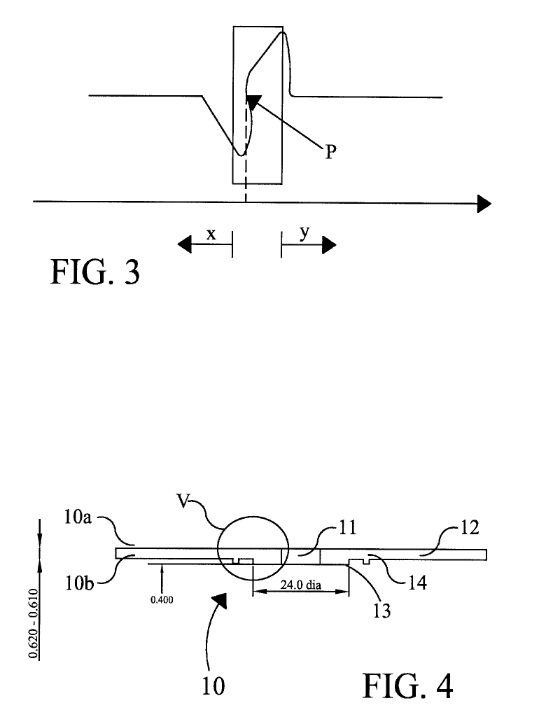

Displacing the lens 6 from a position close to the disc (low) to a position more remote from it (high) generally results in a FE diagram as shown in FIG. 3. The left hand side of the shown graph (denoted region X) corresponds to a too high position of the lens 6 with respect to the focussed position, while the right hand side of the graph (denoted region Y) corresponds to a too low position of the lens 6 with respect to the focussed position. The slope of the FE curve is usually affected by the reflectivity of the disc. Position P corresponds to the desired correct focal plane. The focal plane is preferably located at the following distances, as measured from the inferior clamping means 4, for the formats indicated:

| | |
|---|---|
| DVD 5: | 0.570 − 0.583 + 0.1 (stacking ring) |
| DVD9 L1 | 0.640 − 0.653 + 0.1 |
| CD format | 1.2 ± 0.1 + 0.4 (stacking ring) |

The thickness of each substrate and/or of the finished disc not only ensures a suitable clamping of the disc 1 by the clamping means 3, 4 of the reader, but also enables the laser spot to focus by means of the lens 6 on the reading side of the data substrate.

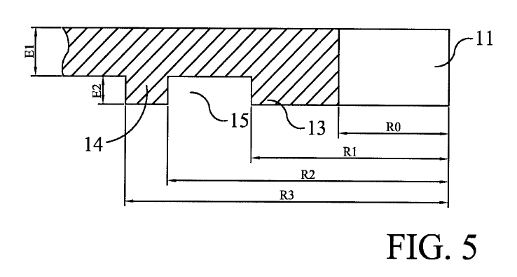

Referring now to FIGS. 4 and 5, a universal numerical disc (for instance, of DVD format) 10 according to the present disclosure is shown having a central opening 11 with a diameter of about 15 mm. The DVD 10 is moulded from a single part having the general shape of a disc 12 with a diameter essentially equal to 120 mm and having a printing side 10a and a reading side 10b. Data are inscribed on side 10b of the DVD 10 which is then metallized in a manner known per se for data substrates, for instance, DVD 5. A protective resin, for instance, a resin curable by irradiation of the polyester and/or epoxide type, is subsequently applied onto the metallized side 10b. Inscriptions may then be printed onto the side 10a of the DVD with the aid of conventionally known apparatus.

Disc shaped part 12 has a thickness of about 0.62 mm and a central increased thickness area 13 that, at the reading side 10b, extends radially from the rim of the opening 11 until a radius of about 12 mm. The side 10b also comprises a ring-shaped rib 14, which extends radially from a radius of about 16 mm to a radius of about 18 mm. Both the increased thickness area 13 and the rib 14 stand out from the side 10b over a thickness of about E2=0.40 mm.

For a DVD 10 format, the dimensions of a disc according to the present disclosure are (with reference to FIG. 5): E1=about 0.62 mm; E2=about 0.40 mm; R0=about 7.5 mm; and R3=about 16 mm.

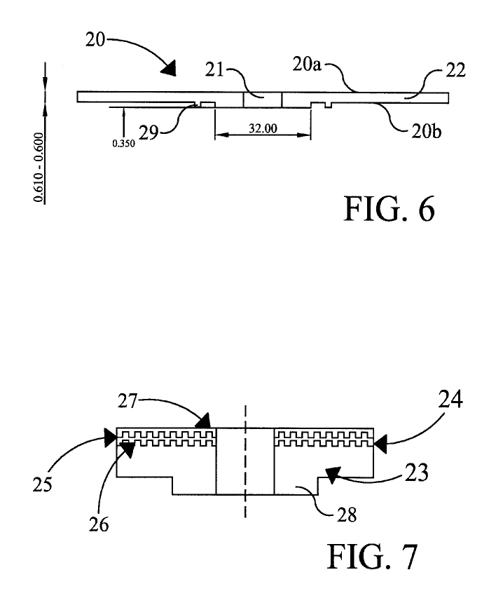

FIG. 6 shows the dimensions of another exemplary embodiment according to the present disclosure. In FIG. 6, a disc 20 is shown having a central opening 21 with a diameter of about 15 mm. The DVD 20 in dual layer format is moulded from a single part having the general shape of a disc 22 with a diameter essentially equal to 120 mm, and having a printing side 20a and a reading side 20b. As shown more in detail in FIG. 7, optical disc 20 comprises only one substrate 23, moulded from, for instance, PC or PMMA. A first semi-reflective layer 24 is provided on the substrate 23, which is formed to include information tracks in the form of pits and bosses. A second aluminium layer 25 is provided on top of the first layer 24 and bonded thereto by adhesive layer 26. A protective layer 27 in the form of a suitable lacquer is provided on top of the second layer 25. The total thickness of the disc 20 is about 0.60 to 0.61 mm with a central increased thickness area 28 that, at the reading side 20b, extends radially from the rim of the opening 21 until a radius of about 16 mm. The side 20b also comprises a ring-shaped rib 29. Both the increased thickness area 28 and the rib 29 stand out from the side 20b over a thickness of about 0.35 mm.

The present disclosure permits production of optical discs of several formats, including DVD+R and DVD−R single layer discs. The disc according to the present disclosure contains less polymer material than known discs, typically 8 grams less. Also, the use of an adhesive to bond together two half discs may be omitted, which further reduces cost. Finally, by providing the disc with a protective layer on the reading side, a complex packaging is avoided. Additional advantages of the disc according to the present disclosure are that it requires less power to spin it up and down, it reduces wear and tear of the disc drive motor, and it is less prone to breakage since it is more flexible. The disc can be applied in all commercially available optical readers. Due to its low weight, a particularly preferred application of the disc is as a publicity item to be included in magazines and the like.

It should be clear to a person skilled in the art that the present disclosure is not limited to the preferred exemplary embodiment discussed above, but that several variations and modifications are possible within the scope of the disclosure as defined in the appended claims.

All patents, patent applications and publications referred to herein are incorporated by reference in their entirety.

1. A universal numerical disc comprising an essentially single moulded generally planar part having a printing side and a readable side carrying encoded data, the moulded part having a central opening and a ring-shaped area with increased thickness, disposed concentrically around central opening at the side of the reading side, the reading side comprises a protective resin coating.

2. The disc of claim 1, wherein the ring-shaped area with increased thickness has an interior diameter essentially equal to the diameter of the central opening.

3. The disc of claim 1, wherein the ring-shaped area with increased thickness has an exterior diameter less than about 28 mm.

4. The disc of claim 3, wherein the ring-shaped area with increased thickness has an exterior diameter of about 24 mm.

5. The disc of claim 1, wherein the singly moulded part has a thickness of about 0.60 mm to about 0.62 mm, and the ring-shaped area with increased thickness has a thickness of about 0.40 mm.

6. The disc of claim 1, further comprising a ring-shaped rib, concentrically disposed around the central opening at the side of the reading side.

7. The disc of claim 2, wherein the ring-shaped area with increased thickness has an exterior diameter less than about 28 mm.
